(19) United States
(12) Patent Application Publication
(10) Pub. No.: US 2005/0091061 A1
(43) Pub. Date: Apr. 28, 2005

(54) Digital sound file playback reproducer

(76) Inventors: Chi-Tung Chang, Taipei County (TW); Hung-Chou Tsai, Nantou County (TW); Jar Haw Lee, Taoyuan City (TW)

Correspondence Address: Chi-Tung Chang, 7F, No. 213, Civic Boulevard. Sec. 4., Taipei, 105, TW

(21) Appl. No.: 10/696,359

(22) Filed: Oct. 27, 2003

(51) Int. Cl. G10L 11/00

(52) U.S. Cl. 704/272

(57) ABSTRACT

A digital sound file playback reproducer includes a housing in which at least a connection port, a sound source output unit, and a processing unit are provided. The connection port is adapted to connect with an external recording medium having sound filed stored thereon. The processing unit picks up and processes the sound files in the externally connected recording medium, and sends the processed sound files to the sound source output unit. Since the digital sound file playback reproducer does not include an internal memory, a consumer of existing recording media, such as memory cards and USB flash disks, could buy it without wasting money in repeated memory.

### FIELD OF THE INVENTION

The present invention relates to a sound file playback reproducer, and more particularly to a digital sound file playback reproducer that is not an internal memory but a unit for connecting to an external recording medium.

### BACKGROUND OF THE INVENTION

Recent rapid developments in information industry have accelerated the coming of digitized era. All kinds of information-related apparatuses surrounding us have a connection with digitization. Even in the field of sound signals, digitization has become an inevitable trend of development. For example, there are developed a number of digitized sound file formats, from WAV developed in early stage providing a CD sound quality to MIDI, MP3, WMA, etc. developed in recent years. Among others, MP3 and WMA have been currently widely used.

MP3 (MPEG Audio Layer-3) is a compression format of sound file. In 1987, Institut Integrierte Schaltungen (IIS), a German research institute, started out a plan named EUREKA EU147 in connection with audio coding and public-address system for digitized sound. This is the origin of MP3. Thereafter, IIS continued the plan in cooperation with Erlangen University, and developed a very powerful algorithmic method, which was certified by the International Organization for Standardization (ISO) and known as MP3.

The audio compression technique adopted by MP3 includes removal of high and low frequency ranges of a sound signal using a particular algorithmic method to largely reduce unnecessary waste of storage capacity and in turn lower the value of digital sound file. Since MP3 reserves only the audio frequency range that is perceptible by human, it provides a sound quality similar to CD sound quality. However, when the file compression ratio is concerned, one second of WAV file providing the CD sound quality would require about 1411.2 KB of storage capacity, while one second of MP3 compressed file requires only about 112˜128 KB of storage capacity. The compression ratio is within the range from 1:10 to 1:12.

ASF (Advanced Streaming File Format) is an audio/video (AV) specification newly introduced by Microsoft to substitute for the existing AVI format and to increase the feasibility of transmission of AV files over network. While ASF simultaneously contains audio and video signals, WMA (Windows Media Audio) is the audio part of ASF. All WMA files have an extension of .WMA, and include three major compression formats. A WMA file having a high grade compression specification provides very good sound quality and compression ratio, and has a size smaller than a MP3 file. (However, it is to be noted that the file size has relation with the compression ratio of the two types of sound formats.) WMA is currently one of the sound compression file formats that are comparable to MP3.

The above-mentioned digital sound file formats, including WAV, MIDI, MP3, and WMA, are frequently used in recently years. Among others, MP3 and WMA are highly popular due to their small file size and good sound quality, as well as easy transmission over networks.

Generally, MP3 and WMA files may be obtained by downloading them via a network to a hard disk of a computer, or to various kinds of recording media, such as a magnetic disk, a compact disk, a memory card, or a USB (Universal Serial bus) flash disk, free of charge or on a basis of payment. The downloaded MP3 or WMA file may be then decompressed using proper software installed in the computer for playback. There are also developed many phonographic apparatuses supporting the playback of files having these formats, so that these files may also be played back if there were not a computer available for use. An MP3 walkman particularly designed for playback of MP3 files has even been developed to satisfy consumers.

The MP3 walkman uses an internal flash memory to store MP3 files. However, since the flash memory is very expensive and the cost thereof is usually as high as one half of the selling price of the walkman, a general MP3 walkman typically does not include the expensive high-capacity internal flash memory. This prevents the MP3 walkman from expansion. Moreover, since the MP3 file must be downloaded via a computer to the internal flash memory of the MP3 walkman, the MP3 walkman has to be always used along with a computer, making it extremely inconvenient when the MP3 file is to be updated.

For consumers of different existing recording media, including memory cards, USB flash disks, etc., it is indeed inconvenient and a pity these recording media are used to store a large quantity of MP3 and WMA files but could not be played back using electronic apparatus other than MP3 walkman or computer. For these consumers, the purchase of an MP3 walkman would only result in idle memory cards and USB flash disks and repeated cost for buying memories.

It is therefore tried by the inventor to develop a digital sound file playback reproducer that is a unit for connecting to an external recording medium, such as a memory card or a USB flash disk, instead of being an internal memory, so as to overcome the inconvenience that a conventional MP3 walkman has to update MP3 files via a computer, and to save consumers of existing recording media, including memory cards and USB flash disks, the costs for repeated resources.

### SUMMARY OF THE INVENTION

A primary object of the present invention is to provide a digital sound file playback reproducer for connecting to external record media instead of being an internal memory. To achieve the above object, the present invention includes:
A housing;
A connection port provided to one side of the housing for a recording medium having sound files stored thereon to externally connect thereto;
A sound source output unit provided to one side of the housing; and
A processing unit provided inside the housing for electrically connecting to the above-mentioned connection port and sound source output unit, so as to pick up and process the sound files in the recording medium, and output the processed sound files to the sound source output unit.

Since the sound file playback reproducer of the present invention, which is not an internal memory, enables external connection to a record medium, such as a memory card or a USB flash disk that has sound files stored thereon, the problem of having to update sound files via a computer as in the case of the conventional MP3 walkman may be overcome, and the consumers of existing recording media need not to waste money to buy repeated resources.

In a preferred embodiment of the present invention, the connection port may be a USB port to provide connection to a recording medium having the same interface, such as a USB flash disk and all kinds of memory cards. In the latter case, a card reader with a USB transmission line is used to connect the memory card to the playback reproducer. Digital sound files in, for example, MP3 (MPEG Audio Layer-3) and WMA (Windows Media Audio) formats all can be played back with the present invention.

The digital sound playback reproducer of the present invention may further include an operating unit for controlling the playback of the sound files, and a power supply unit for providing necessary working power to the present invention.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual diagram of a digital sound file playback reproducer according to a preferred embodiment of the present invention; and

FIG. 2 is a block diagram of the digital sound file playback reproducer of FIG. 1.

### DETAILED DESCRIPTION OF THE PREFERRED EMBODIMENTS

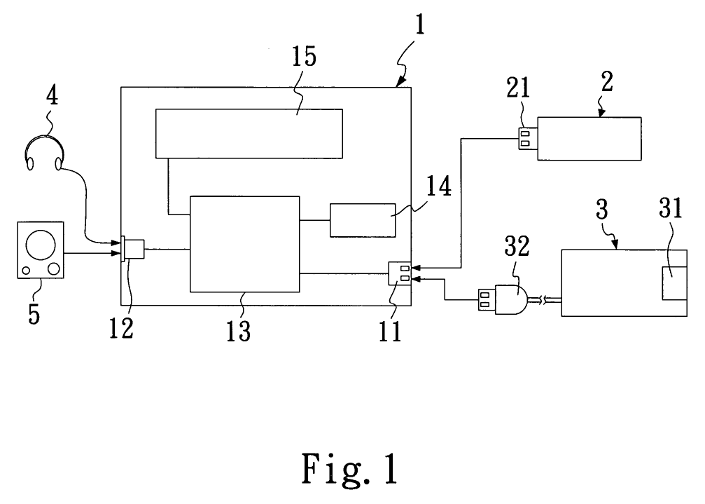

Please refer to FIG. 1 that is a conceptual diagram of a digital sound file playback reproducer according to a preferred embodiment of the present invention. As shown, the digital sound file playback reproducer includes a housing 1, in which a connection port 11, a sound source output unit 12, a processing unit 13, an operating unit 14, and a power supply unit 15 are provided.

The connection port 11 is located at one side of the housing 1, and may be, for example, a USB port for a recording medium having sound files stored thereon, particularly a portable recording medium, to externally connect thereto. It is most preferable the recording medium is a product based on a flash memory, such as a USB flash disk 2 or different types of memory card 31. The USB flash disk 2 includes its own USB connector 21 for direct insert into the connection port 11. The memory card 31 may be a Multi-media Card (MMC), a Compact Flash Card (CF Card), or a Smart Media Card, and must be connected to the connection port 11 via a card reader 3 having a USB transmission line 32.

The sound source output unit 12 is located at one side of the housing 1. In a preferred embodiment, the sound source output unit 12 is a headphone jack for a headphone 4 or a loudspeaker 5 to connect thereto. In another embodiment, the sound source output unit 12 is a loudspeaker directly mounted to an outer side of the housing 1. Therefore, it is no need to connect other external loudspeaker thereto.

The processing unit 13 is located inside the housing 1 and is electrically connected to the connection port 11 and the sound source output unit 12, in order to pick up and process sound files stored in the recording medium, such as the USB flash disk 2 or the memory card 31, and output the processed sound files to the sound source output unit 12.

The operating unit 14 is located at an outer side of the housing 1 and electrically connected to the processing unit 13. Through manipulation of the operating unit 14, the sound files may be played back. The operating unit 14 may also include a display device.

The power supply unit 15 is located inside the housing 1 and electrically connected to the processing unit 13. The power supply unit 15 may be one or more batteries, such as dry batteries or chargeable batteries, to provide the working power needed by the playback reproducer to work. In another embodiment, the power supply unit 15 is a stabilizing and rectifying circuit adapted to connect to a public power source via a power cord.

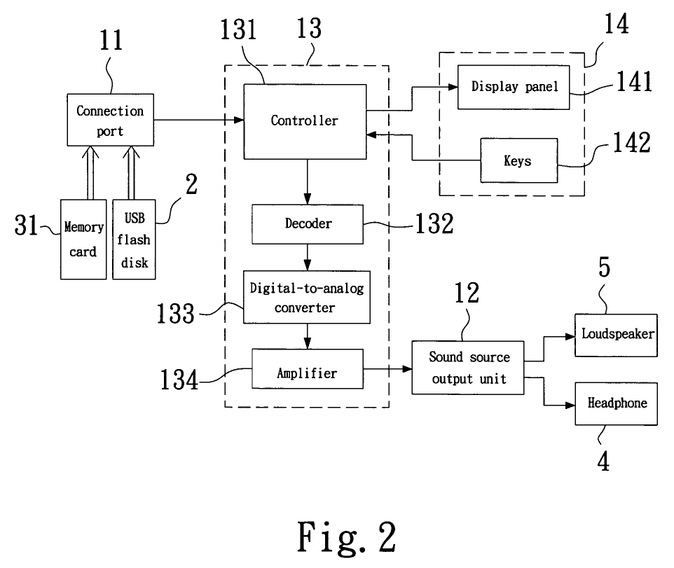

Please refer to FIG. 2 that is a block diagram of the present invention. The operating unit 14 of the above-described digital sound file playback reproducer may include a display panel 141 and a plurality of operating keys 142. Different control signals may be sent via the operating keys 142 to the processing unit 13, at where operations in connection with the following movements are conducted: play, stop, pause, last file, next file, edit playing order, rewind, fast forward, volume control, and power on/off. The display panel 141 may display the status of the above-mentioned operations or the state of playback.

The processing unit 13 sequentially includes a controller 131, a decoder 132, a digital-to-analog converter 133, and an amplifier 134.

The controller 131 is electrically connected to the connection port 11, the operating unit 14, and the decoder 132. The controller 131 may be a microprocessor, or anyone of mono-chips Nos. 6502 and 8051, and includes a read-only memory (ROM) for recording programs or software used to control the streaming-in and streaming-out of sound files, the playback and/or display of relevant information. The controller 131 is also adapted to pick up sound files from the recording media and conduct necessary management and control of the sound files. It is understood the controller 131 is not limited to the above-mentioned microprocessor, but may be a micro-controller, firmware, or other suitable elements. Since the functional principles and the effects of the microprocessor, the micro-controller, or the firmware all are known, they are not discussed herein.

The decoder 132 is used to decompress sound files output from the controller 131. Since the sound files may have a format of, for example, MP3 or WMA, the decoder 132 must have decompression functions supporting these formats.

The digital-to-analog converter 133 is electrically connected to the decoder 132 for receiving digital signals and converting the same into analog signals.

The amplifier 134 is electrically connected to the digital-to-analog converter 133 and the sound source output unit 12 for receiving and amplifying analog signals, and outputting the amplified analog signals to the sound source output unit 12, at where the amplified analog signals are output.

Since the digital sound file playback reproducer of the present invention is not an internal memory but a unit for externally connecting to a recording medium, a user may select a recording medium, such as a USB flash disk 2 or a memory card 31, which has the same connection interface as that of the connection port 11. In the case of a USB flash disk 2, it may be directly inserted into the connection port 11. And, in the case of a memory card 31, it is indirectly connected to the connection port 11 via a card reader 3. The processing unit 13 may pick up any desired sound file from the recording medium. After the picked-up sound file is suitably processed, sound is output via a headphone 4 or loudspeakers 5. A user may control the playback via keys 142 and display penal 141 on the operating unit 14.

The above-mentioned manipulations of the digital sound file playback reproducer of the present invention, and the operation and control procedures of the processing unit 13 vary with different demands. Since such variations are not subject matters of the present invention, and they are fallen in the scope of existing highly matured techniques, they are not discussed in details herein.

In summary, the present invention is superior to the conventional art for the following reasons:
1. It does not require any internal memory and therefore has a largely reduced overall cost.
2. It enables connection to an external recording medium, including the USB flash disk and various kinds of memory cards, which has the same connection interface as that of the present invention. Therefore, it is not necessary to download sound files via a computer, and the sound files may be updated in a quicker and more convenient manner.
3. It allows consumers of existing memory cards and USB flash disks to fully utilize and expand the application of these recording media without the need of repeatedly purchasing expensive flash memory.
4. Since it is connected to external recording media, the problem of non-expandable memory capacity existed in the conventional digital sound file playback apparatus is overcome.

1. A digital sound file playback reproducer, comprising:
a housing;
a connection port located at one side of said housing for an external recording medium having sound files stored thereon to connect thereto;
a sound source output unit located at one side of said housing; and
a processing unit located inside said housing and electrically connected to said connection port and said sound source output unit for picking up and processing sound files in said externally connected recording medium, and sending said processed sound files to said sound source output unit.

2. The digital sound file playback reproducer as claimed in claim 1, wherein said connection port is a USB port.

3. The digital sound file playback reproducer as claimed in claim 1, wherein said sound source output unit comprises a headphone jack.

4. The digital sound file playback reproducer as claimed in claim 1, wherein said processing unit includes at least a controller, a decoder, a digital-to-analog converter, and an amplifier.

5. The digital sound file playback reproducer as claimed in claim 1, further comprising an operating unit located at an outer side of said housing and electrically connected to said processing unit for controlling playback of said digital sound files.

6. The digital sound file playback reproducer as claimed in claim 5, wherein said operating unit includes a plurality of keys.

7. The digital sound file playback reproducer as claimed in claim 5, wherein said operating unit includes a display panel for displaying operation and/or playback status.

8. The digital sound file playback reproducer as claimed in claim 6, wherein said operating unit includes a display panel for displaying operation and/or playback status.

9. The digital sound file playback reproducer as claimed in claim 1, further comprising a power supply unit electrically connected to said processing unit for providing working power needed by said digital sound file playback reproducer to work normally.

10. The digital sound file playback reproducer as claimed in claim 9, wherein said power supply unit comprises at least one battery.

11. The digital sound file playback reproducer as claimed in claim 1, wherein said sound files are MP3 (MPEG Audio Layer-3) files.

12. The digital sound file playback reproducer as claimed in claim 1, wherein said sound files are WMA (Windows Media Audio) files.
